(19) United States
(12) Patent Application Publication
(10) Pub. No.: US 2003/0046141 A1
(43) Pub. Date: Mar. 6, 2003

(54) Method for product planning

(76) Inventor: Irfan A. Kamal, Washington, DC (US)

Correspondence Address: Royal W. Craig, Law Offices of Royal W. Craig, Suite 153, 10 N. Calvert Street, Baltimore, MD, 21202, US

(21) Appl. No.: 10/233,853

(22) Filed: Aug. 30, 2002

Related U.S. Application Data
(60) Provisional application No. 60/315,891, filed on Aug. 30, 2001.

(51) Int. Cl. G06F 17/60

(52) U.S. Cl. 705/10

(57) ABSTRACT

An improved method for product planning including the steps of displaying information about proposed product(s) to a subject, requesting the subject to make a predetermined commitment relating to the proposed products, presenting benefits related to making such commitment, profiling the subject and analyzing the commitment decisions made, compiling a report of the analysis, and making strategic product planning decisions related to the products based on the report. Finally, the commitments made by the subject are fulfilled and commitment and benefit fulfillment is tracked and analyzed. The method for strategic product planning facilitates monitoring, tracking and analysis of new product demand data, and makes strategic product planning more suited for delivery over the internet, whereby commitment transactions and the provision of related benefits can be completed automatically and the results can be monitored, tracked and analyzed online.

### CROSS-REFERENCE TO RELATED APPLICATIONS

The present application derives priority from U.S. provisional application No. 60/315,891 for “METHOD FOR PRODUCT PLANNING”; Filed: Aug. 30, 2001.

### BACKGROUND OF THE INVENTION

1. Field of the Invention

The present invention relates to product planning and, more particularly, to a method and software system for product planning based on the collection and analysis of firm, contingent commitments for the proposed new products.

2. Description of the Background

Companies with established marketing departments often make strategic product planning efforts such as product viability studies, product enhancement studies and attitude and perception studies. These studies are designed to gauge the success of a proposed new product before it is launched. Such studies help to avoid wasted time and effort on unfavorable products. More importantly, they generate feedback by which a company can optimize and adjust its whole product, inclusive of packaging, accessories, instructions for use, etc. These focus studies are typically conducted by a contractor who calls participants at random via telephone and offers them an incentive to participate. The incentive may be monetary or in the form of discounts, coupons or free previews. The process is cumbersome, time consuming and very expensive.

A few companies have begun migrating toward giving simple online surveys over the internet but there are limited quantifiable incentives to take these surveys and the results are often not valid or predictive of actual, mass market purchase interest. It would be greatly advantageous to provide a method for strategic product planning especially suited for use over the internet that requires subjects in the launch group to make firm commitments that can be extensively monitored, tracked and analyzed.

### SUMMARY OF THE INVENTION

Accordingly, it is an object of the present invention to provide a method for strategic product planning by which firm product purchase commitments are negotiated with subjects in advance of, or simultaneous with, the full introduction of the product.

It is another object to provide a method for strategic product planning as described above in which the firm commitments can be monitored, tracked and analyzed.

It is still another object to provide a method for strategic product planning as described above that is especially suited for delivery over the internet, whereby commitment transactions can be completed automatically and the results can be monitored, tracked and analyzed online.

According to the present invention, the above-described and other objects are accomplished by providing a novel method of participation in which subjects are presented with a set of products, are asked to review information on the products, and are asked to make one or more specified firm commitments related to one or more of the products in the set. The firm commitments may have constraints, specifically contingency and irrevocability. In exchange for agreeing to these firm commitments, subjects are guaranteed one or more specific benefits, which may also be contingent, and may also be tiered, for instance, based on the achievement of specific post-launch sales goals. Commitments are monitored and extensively analyzed.

Based on the number, level and type of firm commitments (individual, aggregate or clustered), strategic product decisions can be made during and after the commitment collection process.

The foregoing and other objects of the present invention will be clarified in the following description of the preferred embodiment in connection with the drawings, the disclosure and the appended claims, wherein like reference numerals represent like elements throughout.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a flow chart diagram of the method for strategic product planning according to the present invention illustrating the steps by which firm commitments are negotiated with subjects and the results monitored and analyzed.

FIG. 2 is a sequence of the exemplary information displayed to the subject throughout the process.

FIGS. 3-6 are screen prints from a website implementation of the method of the present invention.

Specifically, FIG. 3 is a screen print of the an exemplary Launch screen 10.

FIG. 4 is a screen print of a detailed product listing.

FIG. 5 is a screen print of an order entry screen where users enter their Conditional Launch Order (“CLO”) commitments.

FIG. 6 is a screen print of the tracking screen by which users can follow the progress of the product(s) that they launched.

### DETAILED DESCRIPTION OF THE PREFERRED EMBODIMENTS

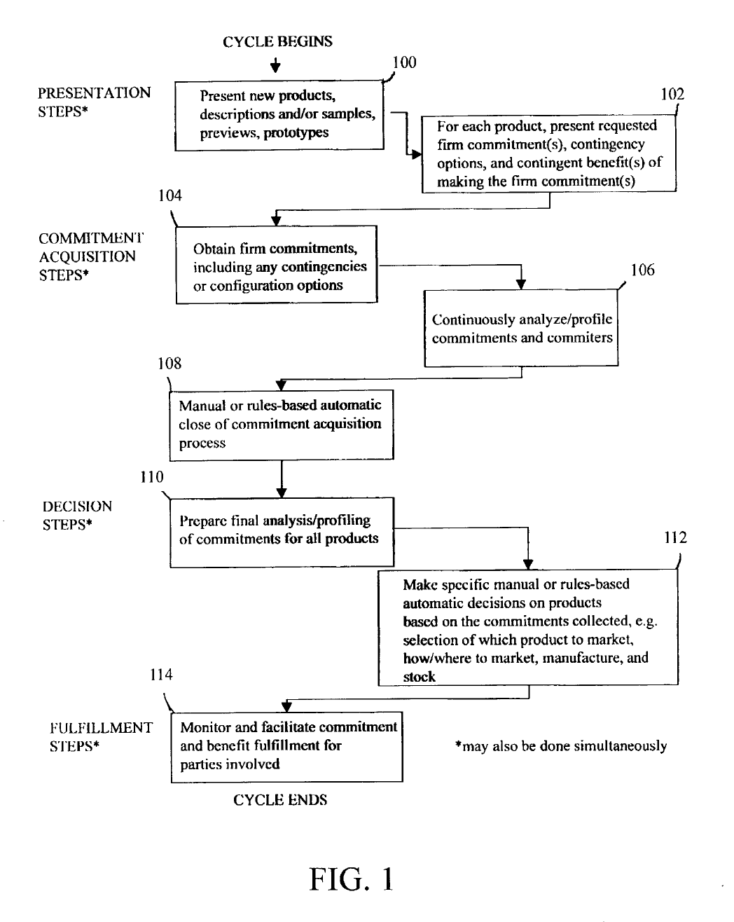

FIG. 1 is a flow chart diagram of the method for strategic product planning according to the present invention illustrating the steps by which firm commitments are negotiated with subjects and the results monitored and analyzed.

As the cycle begins, at step 100 the initial presentation of product categories, products or set of products is typically made to the user through an electronic system, device or computer. The presentation includes a written and, as applicable, model/pictorial/3-D list of products, with a description of each product along with, as appropriate, audio and/or video samples, previews or prototypes. Product descriptions will obviously vary depending on the specific product category, but may include an overview of the product, purpose of the product, target market, information on features or proposed features, financial details on the product, creative aspects of the product, people involved in the product and if relevant, an electronic depiction or sample of the product. Examples of product categories include music, episodic series, games, toys, sporting goods, fragrances, apparel, and motion pictures. Examples of products include a band or song, a television series, a computer game, a toy, a sporting good, an automobile, a fragrance, an article or line of apparel, and a film. Example depictions that will be presented to the subject include a music sample, a series pilot visual/video excerpt, a game level, a toy mock-up, a sporting good prototype, a 3-D automobile concept, a scent, an apparel picture, and a film excerpt or rough cut excerpt.

As shown at step 102, subjects are presented with commitment requests in conjunction with presentation of each product. In each case a commitment is requested of the subject in order to obtain specified benefits related to that product. An exemplary commitment is for the subject to indicate support for a product by placing a non-contingent firm advance order for the product. In that case, the subject would place an advance order for the product at a specified price, typically electronically or over a telephone system, and would provide a method of payment, which would be used to fulfill the advance order commitment. Another form of commitment would be an agreement to perform specified actions. For example, a subject may commit to watch the first five episodes of a new television series and agree to have his/her compliance with this agreement monitored via an agreed-upon monitoring system.

Commitments may, in some circumstances, be permitted to be contingent upon one or more factors, the factors being referred to as “configuration options.” As an example, a commitment to buy a new jacket may be made contingent on its availability in black, its availability in a specified price range, and/or its delivery within six months of making the commitment. Such contingencies can also be expressed as non-binding, that is the firm commitment stands regardless of acceptance of the contingency. Commitments may also, in some circumstances, be permitted to be contingent upon other factors, such as the total number or amount of commitments received for a product.

In conjunction with the step 102 presentation of the product or product set, or at another time prior to or along with the presentation of the commitment requests, the specific benefit or benefits to be provided in exchange for the commitment are also described to the subject. Benefits can range widely, and could include both financial and non-financial benefits. Benefits may also be tiered based on various factors, including the number and type of commitments obtained, and the post-launch success of the product. Examples of benefits include a success-based discount on the expected market price of the product, the early provision of the product to the subject, the ability to influence feature selection, or the ability to receive benefits tied to the success of the product. This latter category of benefits can include, for example, a tiered or non-tiered share in the revenues that are obtained from the product.

After reviewing product descriptions, commitment descriptions and benefit descriptions, the subject completes the commitment acquisition steps. Specifically, at step 104 the subject has the ability to make one or more commitments to indicate his/her support for one or more products. These commitments are typically obtained and stored electronically.

At step 106, commitments are continuously profiled and analyzed, along with information on subjects. Various types of analysis may be performed on the commitments, ranging from cluster analysis to multivariate regression or time series analysis. Correlation and predictive analyses may also be performed to evaluate the impact of or correlation of commitments with such items as products gross sales, rate of sales, subject demographics and market penetrations.

At step 108, once either a specified time period has elapsed and/or a specified number, type or set of commitments has been received, the commitment collection process for the product or product set is ended, either manually or automatically by the system.

The method of the present invention flows to a sequence of decision steps, beginning at step 110 where the analysis/profiling results that were performed on the commitments at step 106 are consolidated, compiled and reported to te decision-maker at step 110.

As shown at step 112, the analyses of commitments and subjects from step 110 are used to make decisions related to the product(s), including the use of aggregated, clustered or individual effects of commitments and/or committing subjects to make product/product category budgeting, financial, product development, marketing, production, manufacturing and inventory decisions. These decisions may be manual or rules-based automatic decisions.

As shown at step 114, after the commitment collection period commitments and benefits provision are fulfilled by the appropriate parties, and the fulfillment of commitments and benefits provision are monitored. In some cases, fulfillment may be electronic; in others, physical (for example, product delivery); or a combination of both. Information on these various aspects of commitment and benefit fulfillment is collected in conventional ways to enable monitoring and tracking.

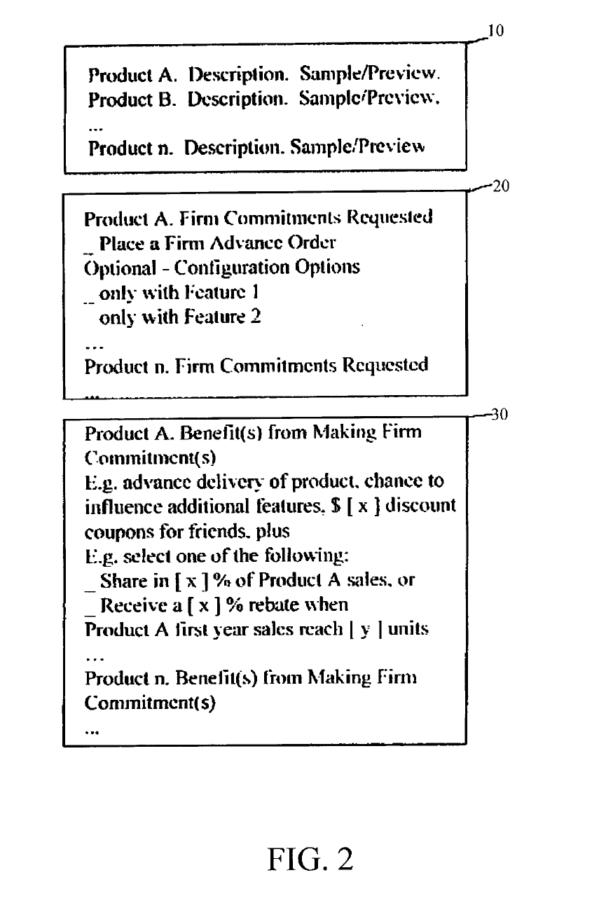

FIG. 2 is a sequence of the exemplary information displayed to the subject throughout the process. Screen 10 illustrates the initial presentation of product descriptions at step 100. The presentation includes a description of each product along with, as appropriate, audio and/or video samples, previews or prototypes. Screen 20 represents the information given to the subject regarding exemplary commitments that they have the ability to make in order to indicate support for the product. Here the commitment is an advance order of the product and two alternative feature choices are given: feature 1 or feature 2.

Screen 30 reflects a variety of specific benefit or benefits to be provided in exchange for the commitment choice by the subject. In this example the benefits include the early provision of the product to the subject, plus a user-selectable choice between a specified share in the revenues that are obtained from the product, or a success-based percentage discount on the anticipated product sales price.

The foregoing method for strategic product planning facilitates monitoring, tracking and analysis of new product demand, and makes strategic product planning more suited for delivery over the internet, whereby commitment transactions can be completed automatically and the results can be monitored, tracked and analyzed online.

The core method is suitable for implementation in software form as an internet exchange, which gives broad exposure to thousands of potential subjects who can combine their resources to launch new products and share in their success.

The software is maintained on a conventional web-enabled central server and is remotely accessible, for example, using a conventional domain name system (DNS) for access over the internet. The program provides a graphical user interface which helps consumers navigate through three basic steps, Explore, Launch and Track.

An exemplary application follows for the music recording industry. In all practicality, most people have little individual influence over what new bands are launched in the music industry. However, if they became part of a group of hundreds or thousands, they would have such influence. The present invention provides the means. The method can be implemented to aggregate or combine demand for a band's music to help fund its launch. In exchange for consumers taking a risk on a new band or their compact disks, consumers share in the upside. It should be understood that music need not be the only application, but other diverse business categories may exist that also are well-suited. In the context of music, the three basic steps are as follows:

1. Explore: The user explores the bands that are competing to be launched (obtain funding for a CD release, a recording contract, etc.).

2. Launch: The user decides which bands they will support by purchasing a commitment, e.g, a conditional launch order (“CLO”). If the band amasses a predetermined minimum number of CLO's, the CLOs are converted into advance orders (e.g., for the band's CD), and the band is lauched. The user earns a share in their success. If the band fails to amass the minimum number of CLO's, the user's CLO is cancelled and they owe nothing.

3. Track: Having submitted a CLO for a particular band, the user becomes a member of a private launch group for the band. During the tracking step the user can follow their progress, take advantage of special events & offers, and keep track of their cash share of their success.

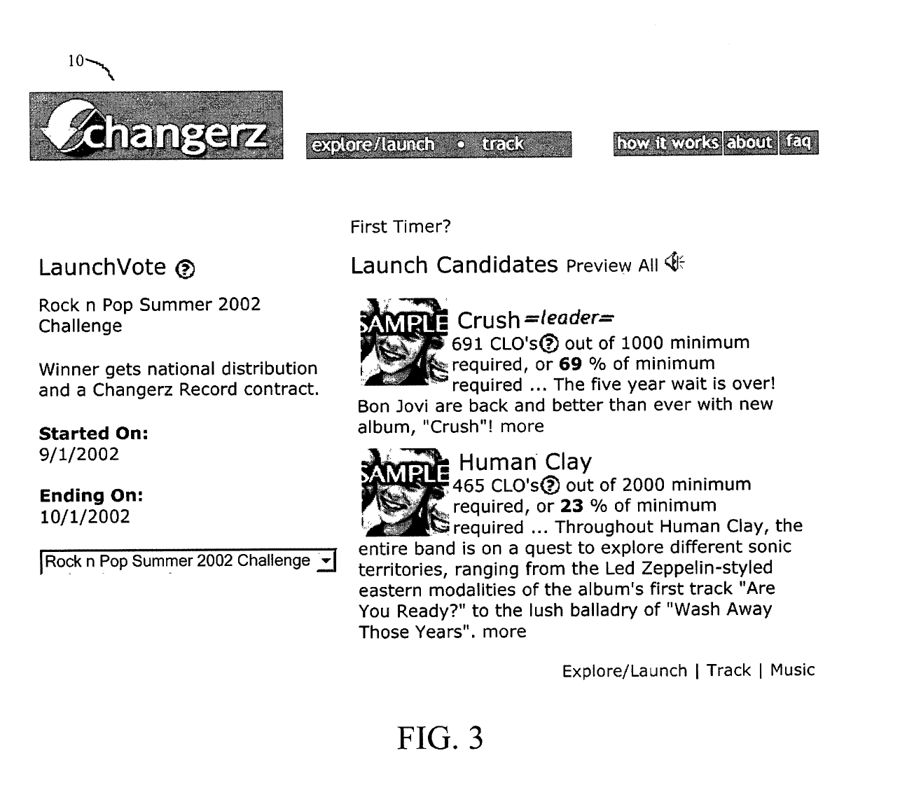

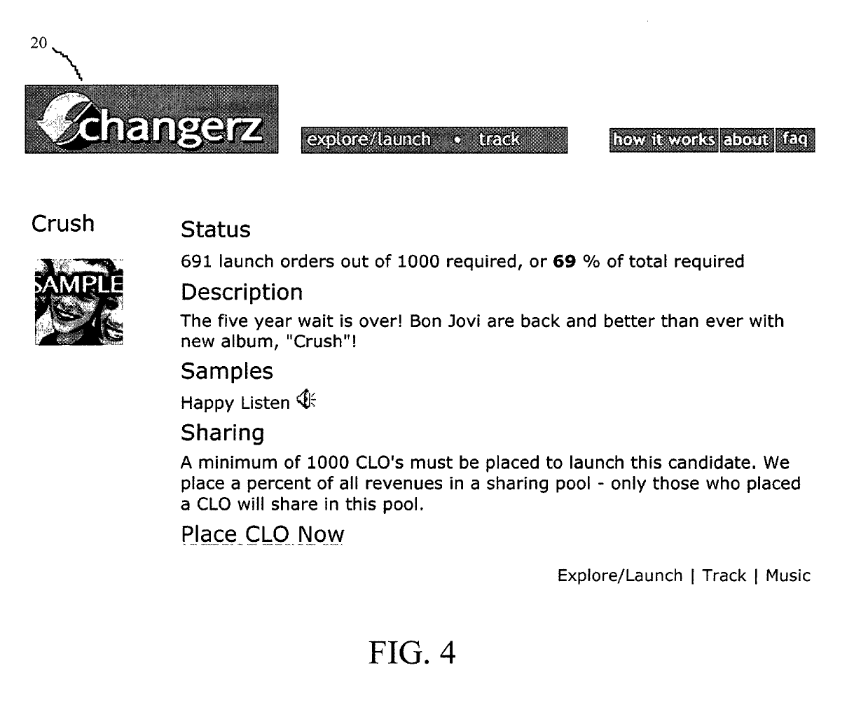

The foregoing steps will now be described in more detail with reference to screen prints from a website which implements the method. Once a user accesses the website, they presented with the Launch screen 10 of FIG. 3. The launch screen 10 provides users with a listing of the bands that are competing for launch orders. It also provides a link to a sample track from the album that they are trying to launch so that the user can preview their work. The launch screen 10 gives the current CLO status for each band. For example, Bon Jovi has amassed 691 of 1000 required CLOs for their new album “Crush”, or 69% of the minimum. Armed with the information available from the launch screen users can determine which bands they are willing to support and can press a button to place a CLO. By clicking on any band listed on the launch screen 10 a user can get a more detailed screen for that band as shown in FIG. 4. Based on the foregoing information and samples, users decide which bands to support and selectively place conditional launch orders (“CLO”) during a “launch vote”.

During the launch vote, bands have two ways to win. First, any band that gets the specified minimum number of CLOs gets a sponsorship contract which may include a record contract, funds to make a video, get radio airplay promotion and tour support. Second, the top band in any LaunchVote, regardless of whether they meet the CLO hurdle, gets the launch vote prize. Users can place CLOs for up to 3 bands in each launch vote cycle. A CLO is simply an advance order for a band's CD, but with a few important differences. First, the CLO is conditional on the CD getting a specified minimum number of CLOs. The user pays nothing if the band fails to achieve the minimum. Second, placing a CLO provides the user with a number of benefits tied to the CD's progress and success. The proceeds of each CLO are used to (1) decide which bands' CD's get launched, and (2) help pay for costs of launching the CD (e.g., making the CD, marketing, promoting, touring, etc.).

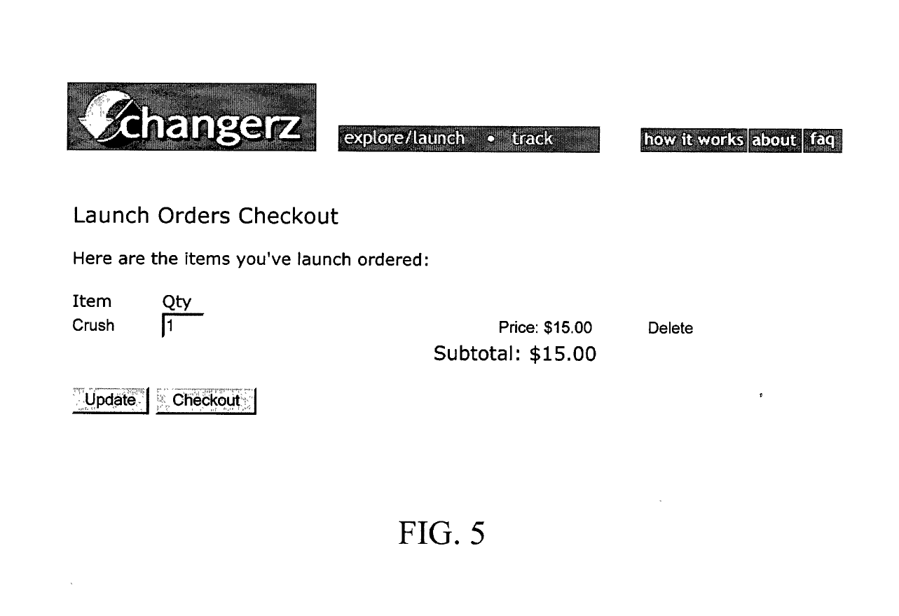

If a user indicates that they wish to place a CLO by depressing the corresponding button in FIG. 4, they are directed to the screen of FIG. 5 where they enter the order. Depending on the launch vote, there may be a standard amount of, for example, $10, that everyone puts at risk.

Alternatively, for some launchers it is possible to allow users to specify how much of their conditional launch order they want to risk. So, for example, if the total CLO price is $13 for a CD, the user might be given an option to risk between $9 and $11. The amount you place at risk is used to help launch the band. The user's benefits, such as their share of revenue, are tied to how much they place at risk. Once a band attains the minimum number of CLOs, the band is “launched” and all supporting users' credit cards are charged the specified amount.

Once the user's order has been entered, the user must login either by entering a pre-established user name and password, or (for new user's) by registering with the system and entering their email address, user name, address, credit charge information, and/or other information as desired.

For each CLO that gets entered, the total amount of the order gets charged in two parts. As described above, the user may specify on occasion how much can be charged immediately (from 50% to about 80% of the order amount). That represents the launch funding amount. The remainder of the order amount, plus shipping and handling, will be charged on shipping the CD. However, all launch orders are final and cannot be cancelled after they are placed. If the band's CD is launched and yet fails (for example, the CD still does not get released), no refund is provided for the pre-billed amount. However, the user will not be billed the part of the order that was scheduled to be billed on shipment of the order. As an example, if they agreed that $10 of a $13 order would be placed at risk, the sponsor would bill the $10 upon launch the CD. If for some reason the band's CD could not be made, the user would lose that amount but not the $3 balance.

In exchange for placing a CLO for a band, the user gets some unique benefits, inclusive of a percentage of the bands worldwide revenues, a chance to see the band, and advance delivery of their CD. Thus, as the launch vote proceeds the software provides a means for users to track the results, while behind the scenes the sponsor can mine the results for demographic data.

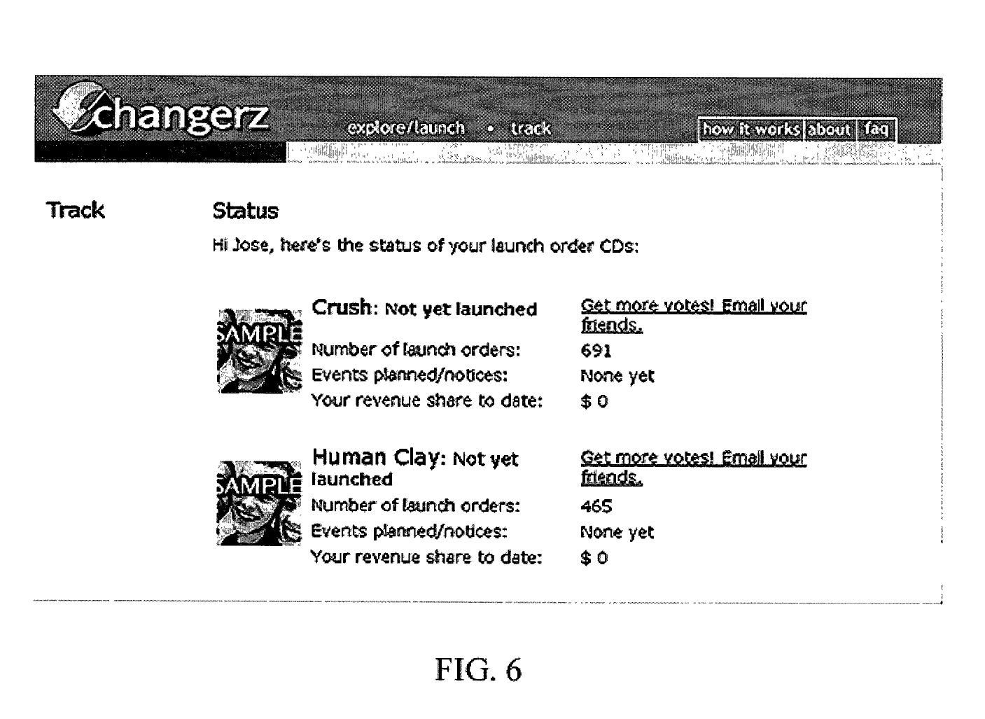

FIG. 6 is a screen print of the tracking screen by which users can follow the progress of the band(s) they launched. Only users who have placed a CLO are given access to the tracking section of the website. In addition to simply tracking the launch vote results, this section allows user's to feel involved, e.g., by reading about life on the road, chatting with the band members—and participating in other cool events exclusively for persons placing launch orders. Users are also updated on their cash share of the sales.

A functional example of the process follows, albeit the numbers are used purely to illustrate the process. If 20,000 people place conditional launch orders (CLOs) for the “ChangerzCool” CD and that equals the minimum required, the sponsor ceases taking CLO's for ChangerzCool. If the user is one of the people who placed a CLO in time, they gain access to the private tracking area of the site in FIG. 6 where they see how much they have earned as a share of the band's success. If 15% was specified as the amount of revenue to be distributed to the CLO group (this number is determined separately by us for each product, and for business reasons, may not be disclosed), and after 6 months the band has sold 500,000 CDs and received revenue of $4 million, then the CLO group (20,000 people) splits 15% of $4 million, or $600,000. If each user had put at risk the same amount, that would translate to $30 per person at the 6 month mark.

It should be understood that the foregoing example is for example purposes.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A method for product planning, comprising the steps of:
displaying information about a proposed product to a subject;
requesting the subject to make a predetermined commitment relating to said proposed product;
providing benefits to all subjects that make a commitment for a product;
profiling the subjects and analyzing the commitment decisions;
compiling a report of said analysis;
making a strategic product planning decision related to the product based on said report;
fulfilling said commitments;
tracking fulfillment of said commitments.

2. The method for product planning according to claim 1, further comprising the step of sponsoring products that attain a predetermined minimum number of commitments.

3. The method for product planning according to claim 3, wherein said commitments further comprise a predetermined monetary amount payable contingent on the respective product receiving a predetermined minimum number of commitments.

4. The method for product planning according to claim 1, wherein said step of profiling the subjects further comprises collecting demographic data from said users for analysis.

5. The method for product planning according to claim 2, wherein said step of providing contingent benefits further comprises providing a percentage of total sales distributed pro rata to the users in accordance with commitments purchased thereby.

6. A system for product planning, comprising a software program for providing a graphical user interface, and a web-enabled server for administering said software program to distributed users, the software program further comprising:
a first section for displaying detailed information about a proposed product to said users;
a second section for allowing users to make contingent monetary commitments relating to a selected product in return for a percentage share of equity income from sales of said product;
a third section for allowing users to track sales of said product.

7. The system for product planning according to claim 6, further comprising the step of sponsoring products that attain a predetermined minimum number of contingent commitments.

8. The system for product planning according to claim 6, wherein said commitments are contingent on the respective product attaining said predetermined minimum number of commitments.

9. The system for product planning according to claim 6, further comprising the step of collecting demographic data from said users for analysis.

10. The system for product planning according to claim 8, wherein the percentage share of equity income from sales of said product equals a percentage of total sales distributed pro rata to the users in accordance with commitments purchased thereby.

11. The system for product planning according to claim 6, wherein only users who have purchased a commitment may access said tracking section.

12. A method for product planning, comprising the steps of:
displaying detailed information about proposed products to said users;
allowing users to select a proposed product and to make a contingent commitment relating to the selected product in return for benefits related to the selected product;
allowing users to track sales of said selected products.

13. The method for product planning according to claim 12, wherein said benefits related to said product comprise a share of income from sales of said product.

14. The method for product planning according to claim 12, further comprising the step of sponsoring products that attain a predetermined minimum number of contingent commitments.

15. The method for product planning according to claim 13, wherein said commitments are contingent on the respective product attaining said predetermined minimum number of commitments.

16. The method for product planning according to claim 12, further comprising the step of collecting demographic data from said users for analysis.

17. The method for product planning according to claim 12, further comprising the step of tracking total contingent monetary commitments collected from all users for strategic planning and prediction purposes.

18. The method for product planning according to claim 12, wherein the percentage share of equity income from sales of said product equals a percentage of total sales distributed pro rata to the users in accordance with commitments purchased thereby.

19. A method for obtaining firm commitments for a product prior to the commercial launch of said product, comprising the steps of:
displaying detailed information about proposed products to said users;
allowing users to select a proposed product and to make a monetary commitment relating to the selected product in return for future benefits related to the selected product;
initiating commercial sales of said product;
allowing users to track the commercial sales of said product.

20. The method for product planning according to claim 19, wherein the monetary commitment is contingent on the product attaining a pre-determined minimum number of monetary commitments from all users prior to commercial sales of said product.
